(19) United States
(12) Patent Application Publication
(10) Pub. No.: US 2020/0086417 A1
(43) Pub. Date: Mar. 19, 2020

(54) ELECTRODE TIP

(71) Applicant: HONDA MOTOR CO., LTD., MINATO-KU, TOKYO (JP)

(72) Inventors: Takahiro MORITA, HAGAGUN, TOCHIGI (JP); Takeshi ARIMITSU, HAGAGUN, TOCHIGI (JP)

(21) Appl. No.: 16/325,116

(22) PCT Filed: Aug. 23, 2017
(86) PCT No.: PCT/JP2017/030067

§ 371 Date: Feb. 12, 2019

(30) Foreign Application Priority Data
Aug. 24, 2016 (JP) 2016-163861

(51) Int. Cl. B23K 11/30; B23K 11/11

(52) U.S. Cl. CPC B23K 11/3018; B23K 11/115

(57) ABSTRACT

The present invention provides an electrode tip with which cooling efficiency can be improved, and with which a pressurization withstanding performance enabling the electrode tip to withstand pressurization during welding can be improved. An electrode tip is provided with: an electrode tip main body portion; and a support post portion which is disposed inside the electrode tip main body portion, and abuts a reverse surface side of a distal end portion of the electrode tip main body portion at least during welding pressurization, to thereby suppress displacement of the distal end portion of the electrode tip main body portion. The support post portion is formed using a material having higher values of tensile strength and Young's modulus than those of the electrode tip main body portion.

### TECHNICAL FIELD

The present invention relates to an electrode tip having a water jacket in which cooling water flows.

### BACKGROUND ART

Conventionally, an electrode tip that is used for spot welding or the like is known to have a structure including a water jacket in which cooling water flows, in order to suppress an increase in temperature of a surface of a distal end portion of the electrode tip. For example, Patent Document 1 discloses such a technology. In Patent Document 1, there is provided description of a configuration in which a cooling water pipe is inserted in an electrode holder, and cooling water flows into the pipe via a passage formed in a power receiving terminal such that an electrode tip is cooled.

Patent Document 1: Japanese Unexamined Utility Model Application, Publication No. H06-86875

### DISCLOSURE OF THE INVENTION

### Problems to be Solved by the Invention

Incidentally, a distal end portion of the electrode tip is formed to have a thickness to the extent that it is possible to withstand a very high pressurizing force during welding. Therefore, even when the cooling water circulates on an internal side, it is difficult to efficiently cool a surface due to the thickness of the distal end portion. If the distal end portion of the electrode tip is thin, the thin distal end portion enables a distance between a distal end surface and the cooling water to be shortened, and thus cooling efficiency is improved; however, the electrode tip is likely to be deformed during pressurization. There is room for improvement in the conventional electrode tip in that sufficient pressurization withstanding performance needs to be compatible with improvement in cooling efficiency.

An object of the invention is to provide an electrode tip with which cooling efficiency can be improved, and with which a pressurization withstanding performance enabling the electrode tip to withstand pressurization during welding can be improved.

### Means for Solving the Problems

The invention relates to an electrode tip (for example, an electrode tip 20 to be described below) having a water jacket (for example, a water jacket 60 to be described below) in which cooling water flows, the electrode tip including: an electrode tip main body portion (for example, an electrode tip main body portion 21 to be described below); and a supporting post portion (for example, a support post portion 31 to be described below) which is disposed inside the electrode tip main body portion, and abuts a reverse surface (for example, a reverse surface 23 to be described below) side of a distal end portion (for example, a distal end portion 22 to be described below) of the electrode tip main body portion at least during welding pressurization, to thereby suppress displacement of the distal end portion of the electrode tip main body portion. The supporting post portion is formed using a material having higher values of tensile strength and Young's modulus than those of the electrode tip main body portion.

In this configuration, even when the electrode tip has a thin distal end part, the supporting post portion formed of a high-strength material can support the distal end portion of the electrode tip main body portion from the reverse surface side of the distal end portion such that it is possible to sufficiently receive a pressing load during welding. As a result, since the supporting post portion enables durability of the distal end portion to be improved, it is possible to realize the electrode tip for welding, with which it is possible to improve both of water cooling performance and pressurization withstanding performance.

It is preferable that the electrode tip further includes an attachment portion (for example, an attachment portion 32 to be described below) that is connected to the supporting post portion and is supported by an inner surface of the electrode tip main body portion so as to support the supporting post portion inside the electrode tip main body portion, in which the attachment portion is provided with a communication portion (for example, a communication portion 33 to be described below) for circulating cooling water.

In this configuration, the attachment portion that supports the supporting post portion is fixed to the inner surface of the very electrode tip main body portion, and thereby it is possible to fix the supporting post portion inside the electrode tip main body portion. Therefore, there is no need to provide, on an outer side of the electrode tip main body portion, a structure for supporting the supporting post portion on the inside, and thus it is possible to simplify a fixing structure of the supporting post portion. In addition, since the attachment portion is provided with the communication portion in which the cooling water flows, it is also possible for the cooling water to flow smoothly, and it is possible to ensure high cooling efficiency.

It is preferable that the inner surface of the electrode tip main body portion is provided with a female thread portion (for example, a female thread portion 25 to be described below), an outer surface of the attachment portion is provided with a male thread portion (for example, a male thread portion 35 to be described below) corresponding to the female thread portion, the male thread portion is screwed to the female thread portion, and the attachment portion is supported on the inner side of the electrode tip main body portion.

In this configuration, it is possible to simplify a support structure that supports the supporting post portion inside the electrode tip main body portion. In addition, it is also possible to regulate a position of the supporting post portion in an axial direction with ease, and thus it is also possible to adjust a pressurizing force on the reverse surface side of the distal end portion with accuracy and ease.

It is preferable that the male thread portion is formed on the entire circumference of the outer surface of the attachment portion, and the communication portion is disposed on an inner side from the male thread portion in a radial direction.

In this configuration, since the male thread portion that is provided on the entire circumference of the attachment portion is screwed to the female thread portion of the electrode tip main body portion, it is possible to reliably support a large load received by the support post portion.

It is preferable that the electrode tip further includes a heat releasing member (for example, a heat releasing member 50 to be described below) that is fixed to be in close contact with a reverse surface of the distal end portion of the electrode tip main body portion and extends toward a proximal end side in an axial direction, in which the heat releasing member is formed using a material having higher thermal conductivity than that of the electrode tip main body portion.

In this configuration, it is possible to more improve the cooling efficiency of the distal end portion by the material (for example, graphite) having higher thermal conductivity than that of a material (for example, a copper alloy) of the electrode tip main body portion and an increase in a surface area that is cooled by the cooling water inside the electrode tip main body portion.

It is preferable that the heat releasing member is formed of graphite.

In this configuration, the graphite having high thermal conductivity is used, and thereby it is possible to still more enhance a heat releasing effect.

It is preferable that the distal end portion of the electrode tip has a surface (for example, a distal end surface 24 to be described below or a surface on a side of a workpiece as a welding target) on an outer side, the surface being coated with tungsten, and a coating diameter of the coated surface viewed in the axial direction is larger than a diameter of the supporting post portion.

In this configuration, even in the case of welding a galvanized steel plate as a workpiece, it is possible to prevent a situation in which metal (for example, copper) reacts with zinc, and the metal of the distal end portion becomes brittle from occurring, and thus it is possible to more improve the durability of the electrode tip. In addition, since a region that is coated with tungsten is set to have a larger diameter than the diameter of the supporting post portion, it is possible to reliably protect a part of the distal end portion, to which a reaction force from the reverse surface side is applied, with tungsten.

### Effects of the Invention

According to the electrode tip of the invention, cooling efficiency can be improved, and a pressurization withstanding performance enabling the electrode tip to withstand pressurization during welding can be improved.

### BRIEF DESCRIPTION OF THE DRAWINGS

FIG. 1 is a view schematically illustrating a distal end part of a spot welding apparatus in which an electrode tip according to an embodiment of the invention is used.

FIG. 2 is a sectional view illustrating an internal configuration of the electrode tip of the embodiment.

FIG. 3 is an exploded perspective view of the electrode tip of the embodiment.

FIG. 4 is a view of a supporting post member of the embodiment when viewed from a proximal end side in an axial direction.

FIG. 5 is a sectional view illustrating a configuration of the supporting post member of the embodiment.

FIG. 6 is a view of the supporting post member of the embodiment when viewed from a distal end side in the axial direction.

FIG. 7 is a view of a nut as a fixing member of the embodiment when viewed from a proximal end side in the axial direction.

### PREFERRED MODE FOR CARRYING OUT THE INVENTION

Hereinafter, a preferred embodiment of the invention will be described with reference to the accompanying drawings.

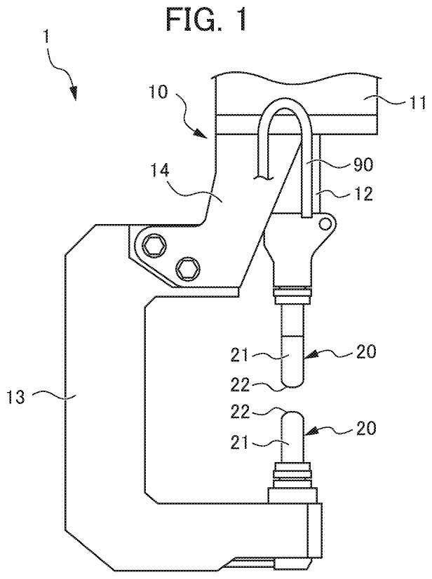

First, an example of a spot welding apparatus 1, in which an electrode tip 20 of the embodiment is used, is described. FIG. 1 is a view schematically illustrating a distal end part of the spot welding apparatus 1 in which the electrode tip 20 according to the embodiment of the invention is used.

The spot welding apparatus 1 includes a welding gun 10 that is attached to a distal end or the like of a robotic arm (not illustrated). The welding gun 10 of the embodiment includes a welding gun main body 11 and a pair of electrode tips 20 that is provided on a distal end of the welding gun main body 11.

On the distal end of the welding gun main body 11, a rod 12, to which the electrode tip 20 provided on a movable side is attached, and a C-type yoke 13, to which the electrode tip 20 provided on a fixed side is attached, are provided.

The rod 12 projects downward from the distal end of the welding gun main body 11 via an extending/retracting mechanism. For example, the extending/retracting mechanism is configured of a servomotor, a feed screw mechanism, or the like and is capable of causing the electrode tip 20 on the movable side to extend and retract with respect to the electrode tip 20 on the fixed side via the rod 12.

The C-type yoke 13 is supported by a connection portion 14 that is connected to the distal end of the welding gun main body 11, and the electrode tip 20 on the fixed side is fixed on the distal end side thereof so as to face the electrode tip 20 on the movable side.

The electrode tip 20 on the movable side and the electrode tip 20 on the fixed side have circular post shapes with the same diameter as each other. A transformer (not illustrated) as a current source is connected to each of the electrode tips 20. For example, a positive electrode of the transformer is connected to the electrode tip 20 on the movable side, and a negative electrode thereof is connected to the electrode tip 20 on the fixed side. In this manner, a welding current that flows into a workpiece from the transformer through the electrode tip 20 on the movable side flows toward the electrode tip 20 on the fixed side and returns to the transformer through the electrode tip 20 on the fixed side.

The spot welding apparatus 1 of the embodiment described above pressurizes the workpiece formed by stacking a plurality of metal members such as steel plates, with the workpiece pinched by the pair of electrode tips 20, and causes a current to flow between the corresponding electrode tips 20 in a state of maintaining a pressurizing force equal to or higher than a predetermined force, thereby welding the workpiece.

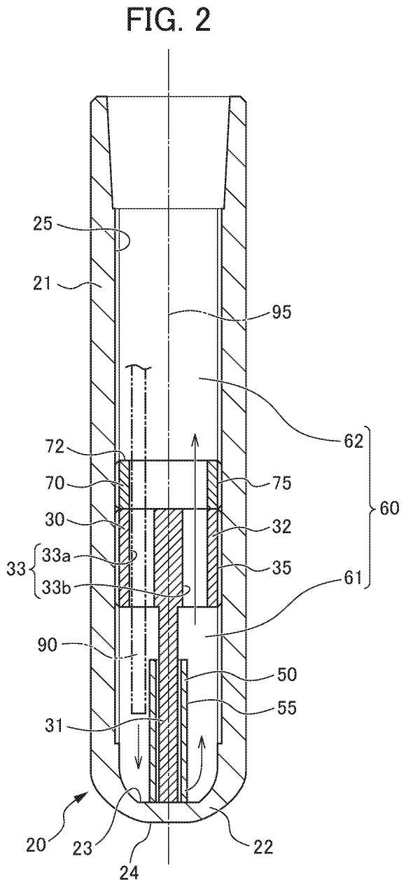

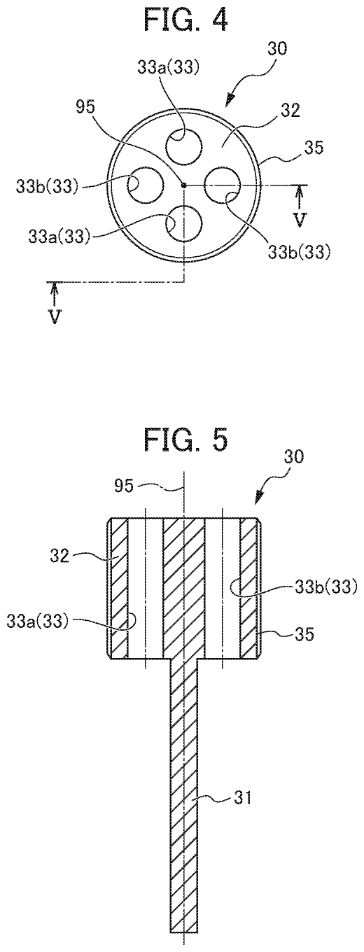

Next, the electrode tip 20 of the embodiment will be described. FIG. 2 is a sectional view (corresponding to a longitudinal section taken along line V-V in FIG. 4) illustrating an internal configuration of the electrode tip 20 of the embodiment. A dot-and-dash line in FIG. 2 represents a center line 95 through the center of the electrode tip 20 in a direction parallel to an axial direction.

As illustrated in FIG. 2, the electrode tip 20 of the embodiment includes, as a principal configuration, an electrode tip main body portion 21, a supporting post member 30, a heat releasing member 50, and a nut 70.

The electrode tip main body portion 21 is made of a copper alloy, and an inside thereof is formed into a bottomed hollow circular post shape (cylinder shape). A hollow part of the electrode tip main body portion 21 functions as a water jacket 60 to be described below.

A distal end surface 24, which is a surface of a distal end portion 22 of the electrode tip main body portion 21 is formed into a spherical surface shape. In the embodiment, the distal end surface 24 of the distal end portion 22, which faces the workpiece, is coated with tungsten and has a tungsten layer.

An inner surface of the electrode tip main body portion 21 is provided with a female thread portion 25. The female thread portion 25 of the embodiment is formed in a region inside the electrode tip main body portion 21 except for regions on a proximal end side and a distal end side.

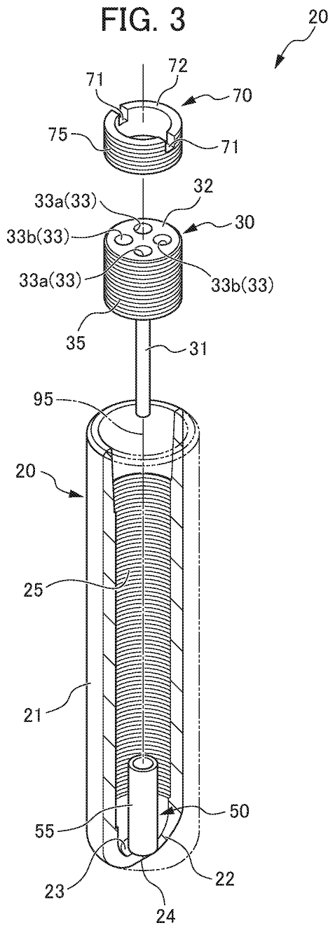

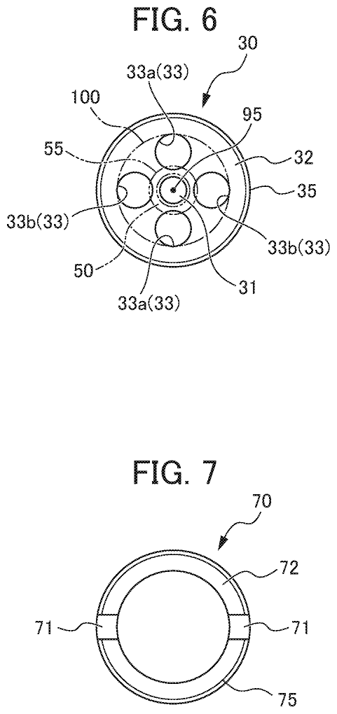

Next, the supporting post member 30 will be described. FIG. 3 is an exploded perspective view of the electrode tip 20 of the embodiment. FIG. 4 is a view of the supporting post member 30 of the embodiment when viewed from the proximal end side in the axial direction. FIG. 5 is a sectional view illustrating a configuration of the supporting post member 30 of the embodiment and a sectional view taken along line V-V in FIG. 4. FIG. 6 is a view of the supporting post member 30 of the embodiment when viewed from the distal end side in the axial direction. Incidentally, screw grooves of the female thread portion 25, a male thread portion 35, and a nut-side male thread portion 75 illustrated in FIG. 3 are schematically illustrated, and a groove shape is not limited to shapes illustrated in the drawing.

As illustrated in FIGS. 3 to 6, the supporting post member 30 is provided with a support post portion 31 formed into a shaft shape and an attachment portion 32 formed into a larger circular post shape than the shape of the support post portion 31.

A proximal end side of the support post portion 31 is connected to the attachment portion 32, and a distal end side thereof faces a reverse surface 23 of the distal end portion 22 of the electrode tip main body portion 21.

The attachment portion 32 is provided with the male thread portion 35 on the entire circumference of an outer surface of the attachment portion, the male thread portion corresponding to the female thread portion 25.

The attachment portion 32 is provided with a plurality of communication portions 33 formed to penetrate the attachment portion in the axial direction. The communication portions 33 of the embodiment are arranged at equal intervals in a circumferential direction, and a total of four communication portions 33 are formed. As illustrated in a bottom view in FIG. 6, the plurality of communication portions 33 are all positioned in a region on an inner side from the outer surface (the male thread portion 35) of the attachment portion 32 in the radial direction and on an outer side from the support post portion 31 in the radial direction and have a positional relationship in which the communication portions do not overlap the support post portion 31 and the male thread portion 35 in the axial direction without reaching the outer surface of the attachment portion 32.

Two communication portions 33 having a positional relationship of facing each other in the radial direction of the four communication portions 33 function as inner communication portions 33a into which cooling water hoses 90 are inserted such that cooling water is guided toward the distal end side. The embodiment has a configuration in which one cooling water hose 90 is disposed in each of the inner communication portions 33a, and the cooling water is supplied by a total of two cooling water hoses 90. On the other hand, the rest of two communication portions, which are adjacent to the inner communication portions 33a and have a positional relationship of facing each other in the radial direction, function as outer communication portions 33b to which the cooling water returns.

The supporting post member 30 is formed using a material having higher values of tensile strength and Young's modulus than those of the material of the electrode tip main body portion 21 (the distal end portion 22). In the embodiment, the electrode tip main body portion 21 is formed using the copper alloy. By contrast, the supporting post member 30 is formed using a material of so-called cemented carbide (super hard alloy) as a material having both of higher tensile strength and Young's modulus than those of the copper alloy.

In addition, the region (tungsten layer) on the distal end surface 24, which is coated with tungsten, is set to have a larger coating diameter viewed in the axial direction than a diameter of the support post portion 31. This can also mean that the coated region is set in a range of at least covering an area of an end surface of the support post portion 31 that is in contact with the reverse surface 23 side of the electrode tip main body portion 21.

The heat releasing member 50 will be described. As illustrated in FIGS. 2 and 3, the heat releasing member 50 is fixed to adhere to the reverse surface 23 of the distal end portion 22 of the electrode tip main body portion 21 and is formed of graphite.

The heat releasing member 50 of the embodiment surrounds the support post portion 31 and is formed into a cylindrical shape extending toward the proximal end side of the support post portion 31. The heat releasing member 50 is disposed in a space on the periphery of the support post portion 31, and the center of the heat releasing member 50 and the center of the support post portion 31 are positioned on the same axis line (center line 95).

In addition, as illustrated in FIG. 6, an outer circumferential surface (outer surface) 55 (two-dot chain line) of the heat releasing member 50 in an axial-direction view is disposed on the inner side in the radial direction from a circumscribed circle 100 (dot-and-dash line) obtained by circumscribing a circle about the plurality of communication portions 33. Therefore, a structure is employed, in which the cooling water hose 90 is unlikely to interfere with the heat releasing member 50, when the cooling water hoses 90 are inserted. In addition, a gap is formed between the support post portion 31 and the heat releasing member 50.

The nut 70 is a fixing member for fixing a position of the supporting post member 30. As illustrated in FIGS. 2 and 3, an outer circumference of the nut 70 of the embodiment is provided with the nut-side male thread portion 75 corresponding to the female thread portion 25.

FIG. 7 is a view of the nut 70 as the fixing member of the embodiment when viewed from the proximal end side in the axial direction. An end surface 72 of the nut 70 on the proximal end side is provided with cutout portions 71 for performing fastening by a fastening tool such as a flat-bladed screwdriver. The cutout portions 71 are formed at two positions that face each other in a radial direction of the end surface 72 of the nut 70 in plan view.

Next, attachment work of the supporting post member 30 and the nut 70 to the electrode tip main body portion 21 will be described. In a state in which the support post portion 31 of the supporting post member 30 faces the distal end side of the electrode tip main body portion 21, the male thread portion 35 that is formed on the outer circumference of the attachment portion 32 is screwed to the female thread portion 25 of the electrode tip main body portion 21.

In a state in which the supporting post member 30 is screwed to the female thread portion 25 inside the electrode tip main body portion 21, the nut-side male thread portion 75 of the nut 70 is screwed to the female thread portion 25 of the electrode tip main body portion 21. Work of fitting the fastening tool such as the flat-bladed screwdriver in the cutout portion 71. An attachment position of the supporting post member 30 is appropriately maintained by the nut 70.

In the embodiment, the attachment position and a shape of the supporting post member 30 are set such that the support post portion 31 is in contact with the reverse surface 23 side of the distal end portion 22 of the electrode tip main body portion 21 through the inner side of the heat releasing member 50. The attachment position of the supporting post member 30 is set such that the support post portion 31 applies a pressing force to the reverse surface 23 side. Consequently, the distal end portion 22 of the electrode tip main body portion 21 comes into a state of receiving pre-stress toward an extending side in the axial direction, and thus a welding load that can be received during welding pressurization is remarkably increased.

Next, flow of the cooling water will be described. The water jacket 60 of the embodiment is configured of a first water jacket 61, which is positioned on the distal end side in the axial direction inside the electrode tip main body portion 21, and a second water jacket 62, which is positioned on the proximal end side in the axial direction thereinside. Also, the first water jacket 61 and the second water jacket 62 communicate with each other through the communication portions 33 formed in the attachment portion 32.

As illustrated by a two-dot chain line in FIG. 2, the cooling water hoses 90 are inserted into the inner communication portions 33a of the communication portions 33 of the attachment portion 32. A distal end of the cooling water hose 90 projects from the inner communication portion 33a and extends to an outer side of an outer circumferential surface 51 of the heat releasing member 50. Consequently, it is possible to efficiently supply the cooling water to a periphery of the heat releasing member 50 and the reverse surface 23 of the distal end portion 22. Incidentally, it is possible to appropriately modify a distal end position of the cooling water hose 90, in accordance with a configuration or the like of the electrode tip 20.

The cooling water supplied from the cooling water hose 90 directly cools the distal end portion 22 of the electrode tip main body portion 21 from the reverse surface 23 side and cools the distal end portion 22 via the heat releasing member 50 having high thermal conductivity. The cooling water after cooling is sent outside the electrode tip 20 through a discharge route (not illustrated) via the gap between the outer communication portions 33b and the inner communication portions 33a and the cooling water hose 90.

In the embodiment, the inner communication portions 33a and the outer communication portions 33b, which are flow channels of the cooling water, are structured to be all positioned not to overlap the support post portion 31 when viewed in the axial direction and not to interfere with flow of the cooling water.

Next, a load that is received by the distal end portion 22 of the electrode tip 20 during the welding pressurization will be described. A distal end of the support post portion 31 having both of higher tensile strength and Young's modulus than those of the distal end portion 22 is disposed to abut the reverse surface 23 of the electrode tip main body portion 21. Consequently, when the electrode tip 20 is pressurized during a welding process (during the welding pressurization), the support post portion 31 receives a load thereof such that displacement of the distal end portion 22 on the proximal end side in the axial direction is suppressed. Consequently, the distal end portion is prevented from being deformed during the welding pressurization, and the state of the distal end portion 22 is appropriately maintained.

In addition, in the embodiment, the male thread portion 35 that is formed on the entire circumference of the outer surface of the attachment portion 32 is screwed to the female thread portion 25 that is formed on the inner surface of the electrode tip main body portion 21, and thereby the support post portion 31 is held inside the electrode tip main body portion 21. Consequently, since substantially the entire outer circumferential surface (screwed part) of the attachment portion 32 can receive the load that is received by the support post portion 31, the support post portion 31 can more reliably perform supporting. As described above, since the communication portions 33 for circulating the cooling water are formed on the inner side from the outer surface (the male thread portion 35) of the attachment portion 32, it can be said that a structure of circulating the cooling water is realized without weakening a holding force obtained by using the outer circumferential surface of the attachment portion 32.

According to the electrode tip 20 of the embodiment described above, the following effects are achieved. In other words, the electrode tip 20 is provided with: the electrode tip main body portion 21; and the support post portion 31 which is disposed inside the electrode tip main body portion 21, and abuts the reverse surface 23 side of the distal end portion 22 of the electrode tip main body portion 21 at least during the welding pressurization, to thereby suppress displacement of the distal end portion 22 of the electrode tip main body portion 21. The support post portion 31 is formed using the material having higher values of tensile strength and Young's modulus than those of the electrode tip main body portion 21. In this configuration, as described in the embodiment, even when the electrode tip 20 has the thin distal end portion 22, the support post portion 31 formed of a high-strength material can support the distal end portion 22 of the electrode tip main body portion 21 from the reverse surface 23 side of the distal end portion such that it is possible to sufficiently receive a pressing load during welding. Since the support post portion 31 enables durability of the distal end portion 22 to be improved, it is possible to realize the electrode tip 20 for welding, with which it is possible to improve both of water cooling performance and pressurization withstanding performance.

In addition, the electrode tip 20 of the embodiment further includes the attachment portion 32 that is connected to the support post portion 31 and is supported by the inner surface of the electrode tip main body portion 21 so as to support the support post portion 31 inside the electrode tip main body portion 21. The attachment portion 32 is provided with the communication portion 33 for circulating the cooling water. In this configuration, the attachment portion 32 that supports the support post portion 31 is fixed to the inner surface of the very electrode tip main body portion 21, and thereby it is possible to fix the support post portion 31 inside the electrode tip main body portion 21. Therefore, there is no need to provide, on the outer side of the electrode tip main body portion 21, a structure for supporting the support post portion 31 on the inside, and thus it is possible to simplify a fixing structure of the support post portion 31. In addition, since the attachment portion 32 is provided with the communication portion 33 in which the cooling water flows, it is also possible for the cooling water to flow smoothly, and it is possible to ensure high cooling efficiency.

In addition, the inner surface of the electrode tip main body portion 21 of the embodiment is provided with the female thread portion 25. The outer surface of the attachment portion 32 is provided with the male thread portion 35 corresponding to the female thread portion 25. The male thread portion 35 of the attachment portion 32 is screwed to the female thread portion 25, and thereby the attachment portion 32 is supported on the inner side of the electrode tip main body portion 21. In this configuration, it is possible to simplify a support structure that supports the support post portion 31 inside the electrode tip main body portion 21. In addition, it is also possible to regulate the position of the support post portion 31 in the axial direction with ease, and thus it is also possible to adjust a pressurizing force on the reverse surface 23 side of the distal end portion 22 with accuracy and ease.

In addition, the male thread portion 35 of the embodiment is formed on the entire circumference of the outer surface of the attachment portion 32, and the communication portion 33 is disposed on the inner side from the male thread portion 35 in the radial direction. In this configuration, since the male thread portion 35 that is provided on the entire circumference of the attachment portion 32 is screwed to the female thread portion 25 of the electrode tip main body portion 21, it is possible to reliably support a large load received by the support post portion 31.

In addition, the electrode tip 20 of the embodiment further includes the heat releasing member 50 that is fixed to be in close contact with the reverse surface 23 of the distal end portion 22 of the electrode tip main body portion 21 and extends toward the proximal end side in the axial direction. The heat releasing member 50 is formed using the material having higher thermal conductivity than that of the electrode tip main body portion 21. In this configuration, it is possible to more improve the cooling efficiency of the distal end portion 22 by the material having higher thermal conductivity than that of the copper alloy of the electrode tip main body portion 21 and an increase in a surface area that is cooled by the cooling water inside the electrode tip main body portion 21. In addition, a configuration in which the heat releasing member 50 is disposed by using a space on the outer side of the support post portion 31 is employed, and thereby the cooling water can also flow smoothly.

In addition, the heat releasing member 50 of the embodiment is formed of graphite. In this configuration, the graphite having high thermal conductivity is used, and thereby it is possible to still more enhance a heat releasing effect.

In addition, the distal end portion of the electrode tip 20 of the embodiment has the distal end surface 24 (a surface on a side of a workpiece as a welding target) on the outer side thereof, the surface being coated with tungsten, and the coating diameter of the coated surface viewed in the axial direction is larger than the diameter of the support post portion 31. In this configuration, even in the case of welding a galvanized steel plate as the workpiece, it is possible to prevent a situation in which copper reacts with zinc, and the metal of the distal end portion 22 becomes brittle from occurring, and thus it is possible to more improve the durability of the electrode tip 20. In addition, since the region that is coated with tungsten is set to have a larger diameter than the diameter of the support post portion 31, it is possible to reliably protect a part of the distal end surface 24, to which a reaction force from the reverse surface 23 side is applied, with tungsten.

As described above, the preferred embodiment of the invention is described; however, the invention is not limited to the embodiment described above, and modification can be appropriately performed.

In the above-described embodiment, the electrode tip main body portion 21 is formed using the copper alloy as the material, and the supporting post member 30 is formed using cemented carbide as the material; however, the materials are not limited thereto. The material of the supporting post portion may be the material having higher Young's modulus and tensile strength than the material of the electrode tip main body portion, and it is possible to appropriately change selection of the material depending on a circumstance.

The above-described embodiment has the configuration in which the support post portion 31 is in contact with the reverse surface 23 of the electrode tip main body portion 21; however, there is no need to have a contact state all the time, and it is also possible to employ a configuration in which the support post portion is in a non-contact state normally and abuts the reverse surface side of the distal end portion of the electrode tip main body portion during the welding pressurization.

The above-described embodiment has a configuration in which the heat releasing member 50 is formed of graphite into the cylinder shape; however, the configuration can be appropriately modified depending on a circumstance. For example, the heat releasing member can have a shape other than the cylinder shape of the above-described embodiment. It is possible to use a heat releasing member provided with a slit or a heat releasing member formed by a plurality of plate-shaped members, or the heat releasing member can also be formed using a material other than graphite.

In the above-described embodiment, the nut 70 is provided as the fixing member; however, it is also possible to omit the nut 70 in some cases.

The apparatus, to which the electrode tip of the invention is used, is not limited to the spot welding apparatus 1 described in the embodiment, and the electrode tip of the invention can be used as any electrode tips of various welding apparatuses.

### EXPLANATION OF REFERENCE NUMERALS

20 ELECTRODE TIP
21 ELECTRODE TIP MAIN BODY PORTION
22 DISTAL END PORTION
23 REVERSE SURFACE
24 DISTAL END SURFACE (SURFACE ON OUTER SIDE, SURFACE ON WORKPIECE SIDE)
25 FEMALE THREAD PORTION
31 SUPPORTING POST PORTION
32 ATTACHMENT PORTION
33 COMMUNICATION PORTION
35 MALE THREAD PORTION
50 HEAT RELEASING MEMBER
60 WATER JACKET

1. An electrode tip having a water jacket in which cooling water flows, the electrode tip comprising:
an electrode tip main body portion; and
a supporting post portion which is disposed inside the electrode tip main body portion, and abuts a reverse surface side of a distal end portion of the electrode tip main body portion at least during welding pressurization, to thereby suppress displacement of the distal end portion of the electrode tip main body portion,
wherein the supporting post portion is formed using a material having higher values of tensile strength and Young's modulus than those of the electrode tip main body portion.

2. The electrode tip according to claim 1, further comprising:
an attachment portion that is connected to the supporting post portion and is supported by an inner surface of the electrode tip main body portion so as to support the supporting post portion inside the electrode tip main body portion,
wherein the attachment portion is provided with a communication portion for circulating cooling water.

3. The electrode tip according to claim 2,
wherein the inner surface of the electrode tip main body portion is provided with a female thread portion,
wherein an outer surface of the attachment portion is provided with a male thread portion corresponding to the female thread portion, and
wherein the male thread portion is screwed to the female thread portion, and the attachment portion is supported on an inner side of the electrode tip main body portion.

4. The electrode tip according to claim 3,
wherein the male thread portion is formed on the entire circumference of the outer surface of the attachment portion, and
wherein the communication portion is disposed on an inner side from the male thread portion in a radial direction.

5. The electrode tip according to claim 1, further comprising:
a heat releasing member that is fixed to be in close contact with a reverse surface of the distal end portion and extends toward a proximal end side in an axial direction,
wherein the heat releasing member is formed using a material having higher thermal conductivity than that of the electrode tip main body portion.

6. The electrode tip according to claim 5,
wherein the heat releasing member is formed of graphite.

7. The electrode tip according to claim 1,
wherein the distal end portion of the electrode tip has a surface on an outer side, the surface being coated with tungsten, and a coating diameter of the coated surface viewed in the axial direction is larger than a diameter of the supporting post portion.

8. The electrode tip according to claim 2, further comprising:
a heat releasing member that is fixed to be in close contact with a reverse surface of the distal end portion and extends toward a proximal end side in an axial direction,
wherein the heat releasing member is formed using a material having higher thermal conductivity than that of the electrode tip main body portion.

9. The electrode tip according to claim 3, further comprising:
a heat releasing member that is fixed to be in close contact with a reverse surface of the distal end portion and extends toward a proximal end side in an axial direction,
wherein the heat releasing member is formed using a material having higher thermal conductivity than that of the electrode tip main body portion.

10. The electrode tip according to claim 4, further comprising:
a heat releasing member that is fixed to be in close contact with a reverse surface of the distal end portion and extends toward a proximal end side in an axial direction,
wherein the heat releasing member is formed using a material having higher thermal conductivity than that of the electrode tip main body portion.

11. The electrode tip according to claim 8,
wherein the heat releasing member is formed of graphite.

12. The electrode tip according to claim 9,
wherein the heat releasing member is formed of graphite.

13. The electrode tip according to claim 10,
wherein the heat releasing member is formed of graphite.

14. The electrode tip according to claim 2,
wherein the distal end portion of the electrode tip has a surface on an outer side, the surface being coated with tungsten, and a coating diameter of the coated surface viewed in the axial direction is larger than a diameter of the supporting post portion.

15. The electrode tip according to claim 3,
wherein the distal end portion of the electrode tip has a surface on an outer side, the surface being coated with tungsten, and a coating diameter of the coated surface viewed in the axial direction is larger than a diameter of the supporting post portion.

16. The electrode tip according to claim 4,
wherein the distal end portion of the electrode tip has a surface on an outer side, the surface being coated with tungsten, and a coating diameter of the coated surface viewed in the axial direction is larger than a diameter of the supporting post portion.

17. The electrode tip according to claim 5,
wherein the distal end portion of the electrode tip has a surface on an outer side, the surface being coated with tungsten, and a coating diameter of the coated surface viewed in the axial direction is larger than a diameter of the supporting post portion.

18. The electrode tip according to claim 6,
wherein the distal end portion of the electrode tip has a surface on an outer side, the surface being coated with tungsten, and a coating diameter of the coated surface viewed in the axial direction is larger than a diameter of the supporting post portion.

19. The electrode tip according to claim 8,
wherein the distal end portion of the electrode tip has a surface on an outer side, the surface being coated with tungsten, and a coating diameter of the coated surface viewed in the axial direction is larger than a diameter of the supporting post portion.

20. The electrode tip according to claim 9,
wherein the distal end portion of the electrode tip has a surface on an outer side, the surface being coated with tungsten, and a coating diameter of the coated surface viewed in the axial direction is larger than a diameter of the supporting post portion.
